(19) United States
(12) Patent Application Publication
(10) Pub. No.: US 2021/0000240 A1
(43) Pub. Date: Jan. 7, 2021

(54) COSMETIC CONTAINER WITH CONVENIENT REFILL STRUCTURE

(71) Applicant: PUM-TECH KOREA CO., LTD, Incheon (KR)

(72) Inventor: Do Hoon LEE, Incheon (KR)

(21) Appl. No.: 16/920,009

(22) Filed: Jul. 2, 2020

(30) Foreign Application Priority Data
Jul. 5, 2019 (KR) 10-2019-81186

(51) Int. Cl. A45D 40/06

(52) U.S. Cl. CPC A45D 40/06; A45D 2040/0056; A45D 2200/05

(57) ABSTRACT

The present invention relates to a cosmetic container with a convenient refill structure, the cosmetic container including: a container body; a refill container coupled to the container body, and accommodated therein with contents; a rotation guide member coupled to one side of the refill container, and at least partially exposed to an outside; and a discharge unit for discharging the contents accommodated in the refill container to the outside, wherein the refill container is screw-coupled to the container body while being inserted into an open bottom of the container body, and the rotation guide member has a finger insertion groove recessed inward of the refill container.

### BACKGROUND OF THE INVENTION

### 1. Field of the Invention

The present invention relates to a cosmetic container, and more particularly, to a cosmetic container with a convenient refill structure, in which a refill container is screw-coupled to an open bottom of a container body, and a rotation guide member is provided at a bottom of the refill container, so that a user is able to easily replace the refill container by rotating the refill container through the rotation guide member.

### 2. Description of the Related Art

In general, in order to perform makeup, various types of cosmetics having various functions and states are selected and used according to preference of a user or characteristics of skin.

Such cosmetics generally have various states such as liquid, powder, gel, and solidified cosmetics. In particular, liquid or gel contents such as skin, lotion, essence, cream, and eye cream except for solid contents such as powder or cake are packaged in various shapes of cosmetic containers.

The cosmetic container includes an outer container having an internal space, and a lid for opening and closing a top of the outer container, wherein the lid has a discharge device for discharging contents, and the discharge device is connected to an airless pump.

In addition, a refill container in which the contents are stored is inserted into the outer container and connected to the discharge device installed at an inner side of the lid, so that the user may discharge a predetermined amount of contents from the cosmetic container for use.

As a conventional refill cosmetic container as described above, Korean Utility Model Registration No. 20-0405326 has been disclosed. According to the related art, an inner container is mounted inside an outer container, and a finishing cap is coupled to a lower portion of the outer container, wherein an elastic latching piece is provided on a side surface of the finishing cap, and the finishing cap is fastened to the lower portion of the outer container through a one-touch scheme by the elastic latching piece. Through the above configuration, the inner container refilled in the outer container may be safely mounted and maintained in the outer container, and a structure of the finishing cap is improved so that the inner container may be refilled more conveniently for use.

However, in a case of the conventional refill cosmetic container, when all the contents stored in the inner container are exhausted so that a refill container needs to be replaced, the finishing cap has to be removed from the outer container. In this case, since the finishing cap is inserted into a lower side of the outer container, it is not easy to separate the finishing cap from the outer container, so that it is difficult to replace the inner container.

In addition, as a conventional refill cosmetic container, Korean Patent Registration No. 10-1252115 has been disclosed. The related art includes: an inner container in which contents are accommodated; a pumping member coupled to an upper portion of the inner container to discharge the contents accommodated in the inner container through a pumping action; an outer container configured to accommodate the inner container and the pumping member, having an open bottom to allow insertion and withdrawal of the inner container and the pumping member, and partially cut on both lower sides thereof to allow the inner container to be gripped and replaced; a discharge unit coupled to an upper portion of the outer container to communicate with the pumping member, and configured to discharge the contents to an outside by the pumping action of the pumping member according to lifting/lowering of the inner container; and an over-cap coupled to the upper portion of the outer container to surround the discharge unit.

However, according to the conventional refill cosmetic container, the inner container and the discharge unit are undercut-coupled to each other, so that sealing ability between the inner container and the discharge unit may be reduced. In addition, when a coupling scheme of the inner container and the discharge unit is changed into a screw-coupling scheme in order to improve the sealing ability, since the inner container is coupled to the outer container while being completely inserted into a lower portion of the outer container, it is not easy to grip and rotate the inner container in a process of coupling the inner container, so that a refill structure may be inconvenient.

Therefore, it is necessary to develop a cosmetic container in which the refill container may be conveniently replaced in association with the outer container or the discharge unit while maintaining the sealing ability of the refill container.

### DOCUMENTS OF RELATED ART

### Patent Documents

Korean Utility Model Registration No. 20-0405326 (published on Jan. 10, 2006), “Refill Cosmetic Container”

Korean Patent Registration No. 10-1252115 (published on Apr. 12, 2013), “Refillable Pumping Ampoule Container”

### SUMMARY OF THE INVENTION

An object of the present invention is to provide a cosmetic container with a convenient refill structure, in which a container body is formed with an open bottom, a refill container is screw-coupled to the container body while being inserted into the open bottom of the refill container such that the container body completely covers the refill container, and a rotation guide member is provided at a bottom of the refill container, so that when replacing the refill container, the refill container may be easily replaced by gripping the rotation guide member and rotating the refill container to couple or decouple the refill container to or from the container body.

According to the present invention, there is provided a cosmetic container with a convenient refill structure, the cosmetic container including: a container body; a refill container coupled to the container body, and accommodated therein with contents; a rotation guide member coupled to one side of the refill container, and at least partially exposed to an outside; and a discharge unit for discharging the contents accommodated in the refill container to the outside, wherein the refill container is screw-coupled to the container body while being inserted into an open bottom of the container body, and the rotation guide member has a finger insertion groove recessed inward of the refill container.

In addition, the container body may be provided on an inner side thereof with a coupling protrusion wheel having a screw thread, and the refill container may be provided at an inlet part thereof with a coupling member having a screw thread, such that the coupling protrusion wheel and the coupling member may be screw-coupled to each other.

In addition, the discharge unit may include: a fixing guide member fixedly coupled to the container body, and having a spiral guide groove; a discharge device for discharging the contents accommodated in the refill container; a fixing member connected to the discharge device, and having a first content discharge passage; a rotation operation cap rotatably coupled to an outer side of the fixing guide member; a rotation lifting/lowering member lifted/lowered while being rotated by the rotation operation cap, and having a guide protrusion and a second content discharge passage; a lifting/lowering member vertically moved up and down by the rotation lifting/lowering member; a discharge member coupled to the rotation lifting/lowering member, and having a discharge port and a third content discharge passage; a discharge member moving plate axially coupled to the rotation lifting/lowering member to horizontally move the discharge member; and a push button lifted/lowered while being rotated together with the rotation lifting/lowering member, and formed on one side thereof with a discharge part outlet.

In addition, the discharge device preferably includes a pump for discharging the contents by a pumping operation.

In addition, when the refill container and the container body are coupled to each other, the refill container may be completely inserted into the open bottom of the container body, the discharge device of the discharge unit may be installed in the refill container, and remaining components of the discharge unit except for the discharge device may be installed in the container body, such that the discharge device and the remaining components of the discharge unit may be connected to each other.

In addition, the rotation guide member may be provided at a lower portion thereof with a rotation handle passing through a center of the rotation guide member, and finger insertion grooves may be formed on both sides of the rotation handle, respectively, so that a finger may be inserted into the finger insertion groove when the container body and the refill container are coupled to and decoupled from each other.

According to an embodiment of the present invention, the container body is formed with the open bottom, the refill container is screw-coupled to the container body while being inserted into the open bottom of the refill container such that the container body completely covers the refill container, and the rotation guide member is provided at the bottom of the refill container, so that when replacing the refill container, the refill container can be easily replaced by gripping the rotation guide member and rotating the refill container to couple or decouple the refill container to or from the container body.

According to an embodiment of the present invention, the rotation guide member is fixedly coupled to a lower portion of the refill container, and the rotation guide member has a portion recessed inward of the refill container to allow a finger of a user to be inserted into the recessed portion, so that the refill container can be easily coupled to and decoupled from the container body through the rotation guide member.

### BRIEF DESCRIPTION OF THE DRAWINGS

FIG. 1 is a perspective view showing a cosmetic container according to one embodiment of the present invention.

FIG. 2 is an exploded perspective view showing the cosmetic container according to one embodiment of the present invention.

FIG. 3 is a sectional view showing the cosmetic container according to one embodiment of the present invention.

FIG. 4 is a sectional view illustrating a state in which a container body and a refill container of the cosmetic container are decoupled from each other according to one embodiment of the present invention.

FIG. 5 is a sectional view illustrating a state in which the refill container of the cosmetic container is coupled to the container body according to one embodiment of the present invention.

FIGS. 6 to 8 are partial perspective views illustrating states in which a discharge member of the cosmetic container is moved horizontally and linearly by a discharge member moving plate according to one embodiment of the present invention.

FIG. 9 is a sectional view illustrating a state in which a rotation operation cap of the cosmetic container is rotated so that a push button is lifted and the discharge member protrudes to an outside according to one embodiment of the present invention.

FIG. 10 is a sectional view illustrating a state in which contents are discharged by pressing the push button of the cosmetic container according to one embodiment of the present invention.

FIG. 11 is a sectional view illustrating a state in which the contents are introduced into a cylinder as the push button of the cosmetic container returns to an original position thereof according to one embodiment of the present invention.

### DETAILED DESCRIPTION OF THE INVENTION

The following detailed description of the present invention refers to the accompanying drawings, which illustrate specific embodiments in which the present invention may be implemented. These embodiments are described in sufficient detail to enable those skilled in the art to implement the present invention. It should be understood that various embodiments of the present invention are different from each other, but need not be mutually exclusive. For example, certain forms, structures, and features described herein may be implemented in other embodiments without departing from the spirit and scope of the present invention with regard to one embodiment. It is also to be understood that a position or arrangement of individual elements in each disclosed embodiment may vary without departing from the spirit and scope of the present invention.

Therefore, the following detailed description is not to be taken in a limiting sense, and the scope of the present invention is to be defined only by the appended claims and includes the scope of equivalents of the claimed invention. In the drawings, like reference numerals refer to the same or similar functions throughout various aspects.

With respect to the terms used in the present invention, general terms that are currently and widely used are selected in consideration of functions of the present invention. However, the meanings of the terms may be changed according to intention of those skilled in the art, a judicial precedent, emergence of a new technology, and the like. In addition, in certain cases, a term may be selected at discretion of the applicant. In such cases, the meaning of the term will be described in detail at the corresponding part in the description of the invention. Therefore, the terms used in the present invention should be defined based on the meanings of the terms and the entire descriptions provided herein without being simply limited to the names of terms.

In the present disclosure, when some part “includes” some elements, unless explicitly described to the contrary, it means that other elements may be further included but not excluded.

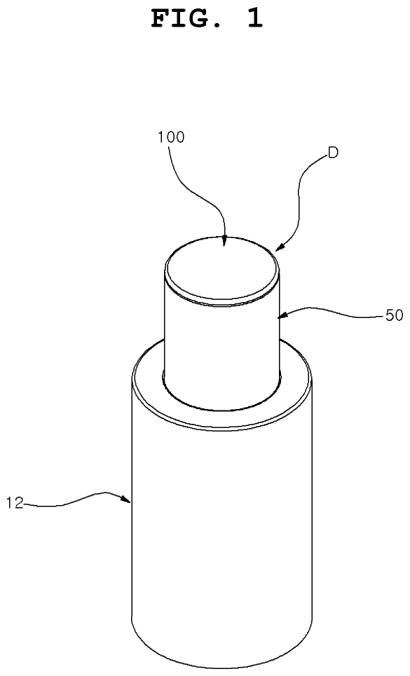

Hereinafter, a cosmetic container with a convenient refill structure according to one embodiment of the present invention will be described with reference to FIGS. 1 to 11.

As shown in the drawings, the cosmetic container according to one embodiment of the present invention may include a container body 12, a refill container 14, a rotation guide member 16, and a discharge unit D. In the following, each component of the cosmetic container according to one embodiment of the present invention will be described in detail with reference to the accompanying drawings.

As shown in FIG. 1, the container body 12 may be configured in the form of a rigid cylinder, and provided on one side thereof the discharge unit D.

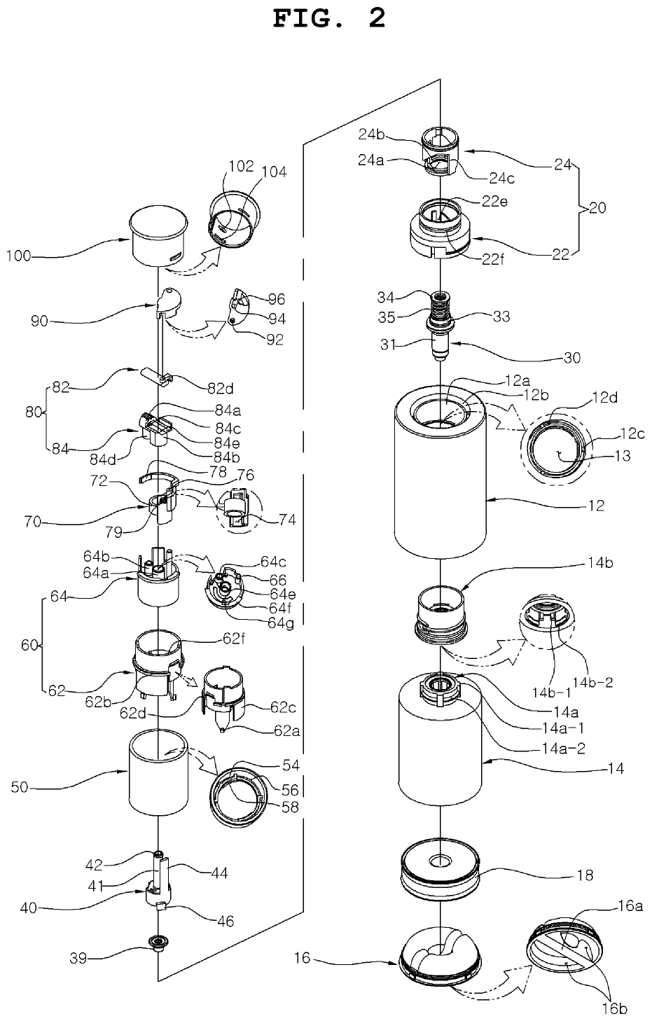

As shown in FIG. 2, the container body 12 may be formed on an inner side thereof with an installation hole 13, a coupling inner wall 12a may be formed on an outer side of the installation hole 13, and a coupling outer wall 12b may be spaced outward from the coupling inner wall 12a by a predetermined interval. The coupling inner wall 12a may be formed at an inner periphery thereof with a screw thread to which the refill container 14 is screw-coupled. A vertical fastening bar 12c may be formed between the coupling inner wall 12a and the coupling outer wall 12b, and a fastening groove 12d may be formed in the coupling outer wall 12b, so that a fixing guide member 20 of the discharge unit D may be fixedly coupled.

In addition, an opposite side of the installation hole 13 of the container body 12 may be configured to be opened, so that the refill container 14 may be inserted into the opposite side of the installation hole 13 of the container body 12.

The refill container 14 may be screw-coupled to the container body 12 while being completely inserted into an open bottom of the container body 12, and contents are accommodated in the refill container 14.

The refill container 14 may be formed at one side thereof with an inlet part 14a, a discharge device 30 of the discharge unit D may be installed in the inlet part 14a, and a coupling member 14b may be coupled to an outer side of the inlet part 14a.

In this case, the coupling member 14b may be configured in the form of a cylinder having an open top and an open bottom, and may be fixedly coupled to the inlet part 14a while surrounding the inlet part 14a. In addition, the coupling member 14b may be formed at an outer periphery thereof with a screw thread that is screw-coupled with the screw thread formed on the coupling inner wall 12a of the container body 12.

In addition, a first rotation prevention protrusion 14a-1 may vertically extend from an outer periphery of the inlet part 14a of the refill container 14, second rotation prevention protrusions 14b-1 may vertically extend from an inner periphery of the coupling member 14b, and the first rotation prevention protrusion 14a-1 may be inserted between the second rotation prevention protrusions 14b-1, so that the coupling member 14b may be prevented from idling with respect to the refill container 14. Further, a first separation prevention protrusion wheel 14a-2 and a second separation prevention protrusion wheel 14b-2 may horizontally extend from an outer periphery of the inlet part 14a and an inner periphery of the coupling member 14b, respectively, so as to be undercut-coupled to each other, so that the coupling member 14b may be prevented from being decoupled from the refill container 14.

Further, an opposite side of the inlet part 14a of the refill container 14 may be configured to be opened, so that the rotation guide member 16 may be coupled to the opposite side of the inlet part 14a of the refill container 14.

The rotation guide member 16 may be fixedly coupled to one side of the refill container 14 and at least partially exposed to an outside, and may serve to assist a user to easily rotate the refill container 14.

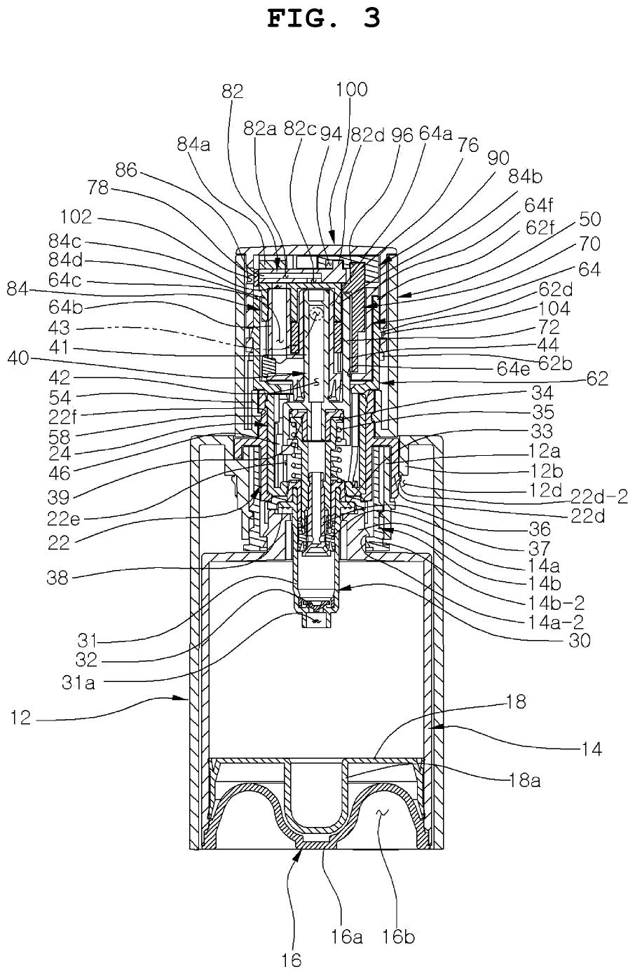

The rotation guide member 16 may be provided at a lower portion thereof with a rotation handle 16a passing through a center of the rotation guide member 16, and finger insertion grooves 16b recessed inward of the refill container 14 may be formed on both sides of the rotation handle 16a, respectively, so that a finger of the user may be inserted into the finger insertion groove 16b when the container body 12 and the refill container 14 are coupled to and decoupled from each other. In this case, as shown in FIG. 3, the finger insertion groove 16b may have a curved surface, and the finger insertion grooves 16b formed on the both sides of the rotation handle 16a are preferably symmetrical to each other.

In addition, the rotation guide member 16 may be formed of a synthetic resin material such as polypropylene or polyethylene. When the rotation guide member 16 is formed of a soft material with a surface having a friction to allow the user to easily grip the rotation guide member 16, the rotation guide member 16 may be formed of at least one of nitrile-butadiene rubber (NBR), urethane rubber, natural rubber, elastomer, silicone, acrylonitrile butadiene styrene (ABS), and thermoplastic plastic elastomer (TPE).

As described above, according to the cosmetic container of one embodiment of the present invention, the refill container 14 is screw-coupled to the open bottom of the container body 12 while being inserted into the open bottom of the container body 12, and the rotation guide member 16 is provided at a bottom of the refill container 14, so that when replacing the refill container 14, the refill container 14 from which the contents are exhausted may be decoupled from the container body 12 by gripping the rotation handle 16a while the finger is inserted into the finger insertion groove 16b of the rotation guide member 16 and rotating the refill container 14 in one direction, and a new refill container 14 may be coupled to the open bottom of the container body 12 by rotating the new refill container 14 while inserting the new refill container 14 into the open bottom of the container body 12. Accordingly, the user may easily replace the refill container 14.

Meanwhile, the refill container 14 may be provided on an inner side thereof with a push plate 18 that is pushed up toward the discharge device 30 within the refill container 14 as the contents are exhausted. A protrusion 18a may protrude downward from a center of the push plate 18, in which the protrusion 18a may be inserted into the rotation handle 16a of the rotation guide member 16 when the push plate 18 is located at the bottom of the refill container 14, and the protrusion 18a may surround a bottom of the discharge device 30 of the discharge unit D when the push plate 18 is located at a top of the refill container 14.

The discharge unit D may include a fixing guide member 20, a discharge device 30, a fixing member 40, a rotation operation cap 50, a rotation lifting/lowering member 60, a lifting/lowering member 70, a discharge member 80, a discharge member moving plate 90, and a push button 100.

The fixing guide member 20 may be fixedly coupled to the installation hole 13 of the container body 12 to guide a rotation and a vertical movement of the rotation lifting/lowering member 60, which will be described below.

The fixing guide member 20 may include a first fixing guide member 22 and a second fixing guide member 24 which are fixedly coupled to each other. As shown in FIG. 3, the second fixing guide member 24 may be inserted into a top of the first fixing guide member 22 so that the first fixing guide member 22 and the second fixing guide member 24 may be fixedly coupled to each other.

As shown in FIG. 2, the first fixing guide member 22 may be formed at a center thereof with a first through-hole 22a, may be formed at an inner periphery thereof with a first spiral guide part 22b and a first rotation prevention wall 22c which are spaced apart from each other by a predetermined interval, and may have a vertical guide groove 22e formed between the first spiral guide part 22b and the first rotation prevention wall 22c. The first spiral guide part 22b may be formed in a diagonal shape to constitute a bottom surface of a spiral guide groove 26.

In addition, a lower extension protrusion wheel 22d may be formed on an outer side of the first fixing guide member 22 so as to be inserted between the coupling inner wall 12a and the coupling outer wall 12b of the container body 12. Further, the lower extension protrusion wheel 22d may have a vertical fastening groove 22d-1 and a fastening protrusion 22d-2, in which the vertical fastening bar 12c of the container body 12 may be inserted into the vertical fastening groove 22d-1, and the fastening protrusion 22d-2 may be coupled to the fastening groove 12d of the container body 12. Accordingly, the fixing guide member 20 may be prevented from being separated from the container body 12 or idling with respect to the container body 12. In addition, a coupling ring groove 22f may be formed in an upper portion of the lower extension protrusion wheel 22d.

The second fixing guide member 24 may be formed at a center thereof with a second through-hole 24a, and a second spiral guide part 24b and a second rotation prevention wall 24c may be provided on an outer wall of the second fixing guide member 24. The second spiral guide part 24b may be formed in a diagonal shape to constitute a top surface of the spiral guide groove 26, and the second rotation prevention wall 24c may make close contact with the first rotation prevention wall 22c of the first fixing guide member 22 to prevent the second fixing guide member 24 from idling with respect to the first fixing guide member 22.

In addition, the fixing guide member 20 may be formed at an inner side thereof with the spiral guide groove 26 that is formed in a diagonal shape along a circumference of the fixing guide member 20. As described above, the spiral guide groove 26 is preferably a space between the first spiral guide part 22b formed on the first fixing guide member 22 and the second spiral guide part 24b formed on the second fixing guide member 24.

In the drawings of the cosmetic container according to one embodiment of the present invention, although the fixing guide member 20 has been shown as being divided into the first fixing guide member 22 and the second fixing guide member 24 which are coupled to each other, embodiments are not limited thereto, and the first fixing guide member 22 and the second fixing guide member 24 may be configured as one component.

The discharge device 30 may be installed in the inlet part 14a of the refill container 14 to discharge the contents accommodated in the refill container 14 to the outside. In this case, the discharge device 30 is preferably an airless pump for discharging the contents by a pumping operation.

As shown in FIG. 3, the discharge device 30 may be coupled to the inlet part 14a of the refill container 14, and may include: a cylinder 31 formed at a bottom thereof with a content suction port 31a; a suction valve plate 32 for opening and closing the content suction port 31a of the cylinder 31; a sealing member 33 coupled to an upper portion of the cylinder 31 while surrounding the upper portion of the cylinder 31; a vertical movement member 34 configured to move up and down at an upper portion of the sealing member 33; an elastic member 35 for elastically supporting the vertical movement member 34; an operation discharge pipe 36 coupled to the vertical movement member 34 to move up and down together with the vertical movement member 34; and an operation discharge ring 37 fitted to an outer side of the operation discharge pipe 36 to make close contact with an inner periphery of the cylinder 31.

In this case, the discharge device 30 may further include a sealing ring 38 provided between the cylinder 31 of the discharge device 30 and the inlet part 14a of the refill container 14 to increase sealing ability of the refill container 14.

Meanwhile, the sealing ring 38 may be formed of an elastic material to further improve the sealing ability of the refill container 14. The sealing ring 38 is preferably formed of at least one of urethane rubber, natural rubber, elastomer, nitrile-butadiene rubber (NBR), and silicone, or a material including polypropylene, polyethylene, and acrylonitrile butadiene styrene (ABS) having elasticity. In particular, the sealing ring 38 is most preferably formed of thermoplastic plastic elastomer (TPE) which is a material having an intermediate form of rubber and plastic that are soft and have excellent durability.

In addition, a connection member 39 may be further coupled to the vertical movement member 34 of the discharge device 30 so as to be fitted to a lower portion of the fixing member 40. The connection member 39 is preferably formed of an elastic material so as to maintain a sealing state while tightly surrounding a lower outer periphery of the fixing member 40.

The fixing member 40 may be coupled to the vertical movement member 34 of the discharge device 30 to transmit a pressing force to the discharge device 30 when the push button 100 is pressed.

As shown in FIG. 3, the fixing member 40 may be provided at a center thereof with a first content discharge pipe 41, the first content discharge pipe 41 may be formed therein with a first content discharge passage 42 connected to the discharge device 30, and the first content discharge pipe 41 may be formed on one side thereof with a first discharge hole 43 connected to a second content discharge passage 63 of the rotation lifting/lowering member 60. In this case, the first content discharge passage 42 may be formed in a content discharge direction of the discharge device 30.

The first content discharge pipe 41 of the fixing member 40 may be provided on an outer side thereof with a rotation limiting part 44 extending in a longitudinal direction of the fixing member 40, and the rotation limiting part 44 allows the lifting/lowering member 70 to vertically move up and down without rotating when the rotation operation cap 50 rotates.

In addition, a vertical guide protrusion 46 may protrude outward from the fixing member 40. A pair of vertical guide protrusions 46 may be provided on a lower outer side of the fixing member 40, and the vertical guide protrusion 46 may be inserted into the vertical guide groove 22e of the fixing guide member 20 to guide a vertical movement of the fixing member 40 while being pressed by a lower end of a first rotation lifting/lowering member 62 when the push button 100 is pressed.

The rotation operation cap 50 may be configured in the form of a cylinder having an open top and an open bottom, and may be rotatably coupled to an outer side of the fixing guide member 20. As the push button 100 is lifted or lowered while the content discharge passage is opened or closed through a rotation operation of the rotation operation cap 50, at least a part of the discharge member 80 may be inserted into the push button 100 or may protrude out of the push button 100.

As shown in FIGS. 2 and 3, the rotation operation cap 50 may be formed an inner side thereof with a seating part 54 and an insertion space 56, in which a rotation lifting/lowering member 60 may be seated on the seating part 54, and a lower portion of the rotation lifting/lowering member 60 may be partially inserted into the insertion space 56. In addition, a coupling protrusion 58 may protrude inward from an inner periphery of the rotation operation cap 50 so as to be rotatably coupled to the coupling ring groove 22f of the fixing guide member 20.

The rotation lifting/lowering member 60 may be coupled to an inner side of the rotation operation cap 50, and may move up and down while being rotated by the rotation operation of the rotation operation cap 50.

As shown in FIG. 2, the rotation lifting/lowering member 60 may include a first rotation lifting/lowering member 62 and a second rotation lifting/lowering member 64 which are fixedly coupled to each other. As shown in FIG. 3, the second rotation lifting/lowering member 64 may be inserted into a top of the first rotation lifting/lowering member 62 so that the first rotation lifting/lowering member 62 and the second rotation lifting/lowering member 64 may be fixedly coupled to each other.

First, a guide protrusion 62a may protrude from a lower portion of the first rotation lifting/lowering member 62, and the guide protrusion 62a may be inserted into the spiral guide groove 26 of the fixing guide member 20 to guide the first rotation lifting/lowering member 62 such that the first rotation lifting/lowering member 62 may move up and down while rotating. In addition, when the guide protrusion 62a is located on the vertical guide groove 22e, that is, when the push button 100 is fully lifted and the discharge member 80 protrudes out of the push button 100 according to the rotation operation of the rotation operation cap 50, the guide protrusion 62a may be moved downward by a pressure applied by the push button 100 so as to press a top of the vertical guide protrusion 46 of the fixing member 40.

In addition, a seating protrusion part 62b may be formed along a circumference of the first rotation lifting/lowering member 62 at an outer periphery of the first rotation lifting/lowering member 62 so as to be seated on a top of the seating part 54 of the rotation operation cap 50, an insertion part 62c may extend from a lower side of the seating protrusion part 62b so as to be inserted into the insertion space 56 of the rotation operation cap 50. Accordingly, the first rotation lifting/lowering member 62 may rotate together with the rotation operation cap 50 while being seated inside the rotation operation cap 50.

Further, a push button fastening protrusion 62d may be formed on an upper side of the seating protrusion part 62b of the first rotation lifting/lowering member 62 so as to be coupled with the push button 100, and the first rotation lifting/lowering member 62 may be formed at an upper end thereof with a seating sill 62f on which the second rotation lifting/lowering member 64 is seated.

Next, the second rotation lifting/lowering member 64 may be inserted into a top of the first rotation lifting/lowering member 62 so as to move up and down while rotating together with the first rotation lifting/lowering member 62.

The second rotation lifting/lowering member 64 may be provided at a center thereof with a center insertion pipe 64a, the first content discharge pipe 41 of the fixing member 40 may be inserted into the center insertion pipe 64a, and a second content discharge pipe 64b may be formed adjacent to the center insertion pipe 64a.

The second content discharge pipe 64b may be biased to one side from the center of the second rotation lifting/lowering member 64, and a second content discharge passage 64c may be formed inside the second content discharge pipe 64b. The second content discharge passage 64c may be connected to or blocked from the first content discharge passage 42 of the fixing member 40 by a rotation and a vertical movement of the second rotation lifting/lowering member 64, and one end of the second content discharge pipe 64b may be connected to a third content discharge passage 84 of the discharge member 80.

The second rotation lifting/lowering member 64 may be formed in a bottom surface thereof with a vertical through-hole 64e, the rotation limiting part 44 of the fixing member 40 may pass through the vertical through-hole 64e, and a range of rotation of the second rotation lifting/lowering member 64 may be limited by the vertical through-hole 64e and the rotation limiting part 44.

In more detail, the rotation limiting part 44 of the fixing member 40 passes through the vertical through-hole 64e of the second rotation lifting/lowering member 64, in which the second rotation lifting/lowering member 64 may rotate together with the first rotation lifting/lowering member 62 while the fixing member 40 is fixed to an inner side of the fixing guide member 20, and a length of the vertical through-hole 64e may be greater than a width of the rotation limiting part 44, so that when the second rotation lifting/lowering member 64 is rotated, both side walls of the vertical through-hole 64e may be latched to the rotation limiting part 44, which limits the range of rotation of the second rotation lifting/lowering member 64 to a predetermined level.

In addition, a seating protrusion 64f may protrude outward form a top of the second rotation lifting/lowering member 64 so as to be seated on the seating sill 62f of the first rotation lifting/lowering member 62, and the seating protrusion 64f may be formed on an inner side thereof with at least one friction protrusion insertion groove 64g.

Further, a rotation shaft 66 having a rod shape may extend from one side of the second rotation lifting/lowering member 64, and the discharge member moving plate 90 may be rotatably coupled to the rotation shaft 66.

In the drawings of the cosmetic container according to one embodiment of the present invention, although the rotation lifting/lowering member 60 has been shown as being divided into the first rotation lifting/lowering member 62 and the second rotation lifting/lowering member 64 which are coupled to each other, embodiments are not limited thereto, and the first rotation lifting/lowering member 62 and the second rotation lifting/lowering member 64 may be integrally formed, that is, configured as one component.

The lifting/lowering member 70 may be inserted into the rotation lifting/lowering member 60 so as to be vertically moved up and down by the rotation lifting/lowering member 60.

As shown in FIG. 2, the lifting/lowering member 70 may be provided at a center thereof with an insertion ring 72 fitted to an outer side of the center insertion pipe 64a of the second rotation lifting/lowering member 64, and may be formed at an inner periphery thereof with a rotation limiting groove 74 into which the rotation limiting part 44 of the fixing member 40 is inserted. Accordingly, the lifting/lowering member 70 may be vertically moved up and down from the fixing member 40 without being rotated according to the second rotation lifting/lowering member 64.

In addition, a fixing rod 76 for guiding an axial rotation direction of the discharge member moving plate 90 may extend upward from one upper side of the lifting/lowering member 70, and a blocking part 78 for blocking a discharge port 82 of the discharge member 80 may be provided at one upper side of the lifting/lowering member 70. In other words, the fixing rod 76 may be inserted into a bottom of the discharge member moving plate 90 to control a rotation direction of the discharge member moving plate 90 such that the discharge member moving plate 90 may be axially rotated about the rotation shaft 66 of the second rotation lifting/lowering member 64, and the blocking part 78 may be configured in the form of a long curved rod provided along a circumference of the second rotation lifting/lowering member 64 to block the discharge port 82 of the discharge member 80.

Further, a friction protrusion 79 may protrude outward from a top of the lifting/lowering member 70 so as to be inserted into a friction protrusion insertion groove 64g of the second rotation lifting/lowering member 64. In more detail, the friction protrusion 79 may be inserted into one friction protrusion insertion groove 64g formed in the second rotation lifting/lowering member 64, may be pressed against an inner wall of the second rotation lifting/lowering member 64, which is rotated when the rotation operation cap 50 is rotated, so as to be bent, and may be elastically inserted into another friction protrusion insertion groove 64g when the second rotation lifting/lowering member 64 rotates by a predetermined distance. Accordingly, an operation feeling of the rotation operation cap 50 may be improved.

The discharge member 80 may serve to discharge the contents accommodated in the container body 12 to the outside.

As shown in FIG. 2, the discharge member 80 may include a discharge part 82 and a guide part 84 for guiding the discharge part 82 such that the discharge part 82 may move horizontally and linearly, which are coupled to each other.

The discharge part 82 may be rotated by the second rotation lifting/lowering member 64 so as to laterally deviate from the blocking part 78 of the lifting/lowering member 70 or so as to be hidden inside the blocking part 78, and may be pushed by the discharge member moving plate 90 so as to be inserted into the push button 100 or to protrude out of the push button 100. As shown in FIG. 3, the third content discharge passage 82a may be formed on an inner side of the discharge part 82, a discharge port 86 may be formed at an end of the third content discharge passage 82a, a third discharge hole 82c may be formed at a bottom of the third content discharge passage 82a on an opposite side of the discharge port 86, and an operation protrusion 82d may protrude from a top of the discharge part 82.

In addition, the guide part 84 may be fitted to outer sides of the center insertion pipe 64a and the second content discharge pipe 64b of the second rotation lifting/lowering member 64 so as to rotate together with the second rotation lifting/lowering member 64. The guide part 84 may be formed on one side thereof with a discharge part insertion ring 84a into which the discharge part 82 is fitted, and the discharge part insertion ring 84a may be formed at a lower portion thereof with a connection hole 84c connected to the second content discharge passage 64c of the second rotation lifting/lowering member 64. The guide part 84 may be formed at a lower portion thereof with a first coupling protrusion wheel 84b coupled to an upper portion of the center insertion pipe 64a of the second rotation lifting/lowering member 64 while covering the upper portion of the center insertion pipe 64a, and a second coupling protrusion wheel 84d coupled to an upper portion of the second content discharge pipe 64b of the second rotation lifting/lowering member 64 while covering the upper portion of the second content discharge pipe 64b. In addition, a guide groove 84e may be formed in an upper portion of the guide part 84 while extending in a direction toward the discharge part insertion ring 84a so as to guide forward and rearward horizontal movements of the discharge part 82.

In addition, the discharge part 82 may be inserted into the discharge part insertion ring 84a of the guide part 84 so as to be moved forward and rearward, and when the discharge part 82 moves forward to protrude out of the push button 100, the third discharge hole 82c of the discharge part 82, the connection hole 84c of the guide part 84, and the second content discharge passage 64c of the second rotation lifting/lowering member 64 may be connected to each other.

The discharge member moving plate 90 may be axially coupled to the rotation shaft 66 of the second rotation lifting/lowering member 64 while being connected to the lifting/lowering member 70 and the discharge member 80 so as to move the discharge member 80 horizontally and linearly. As shown in FIG. 2, the discharge member moving plate 90 may be configured in the form of a semi-circular plate, and is preferably located on an inner side of the push button 100 and upper portions of the second rotation lifting/lowering member 64, the lifting/lowering member 70, and the discharge member 80 for a smooth operation.

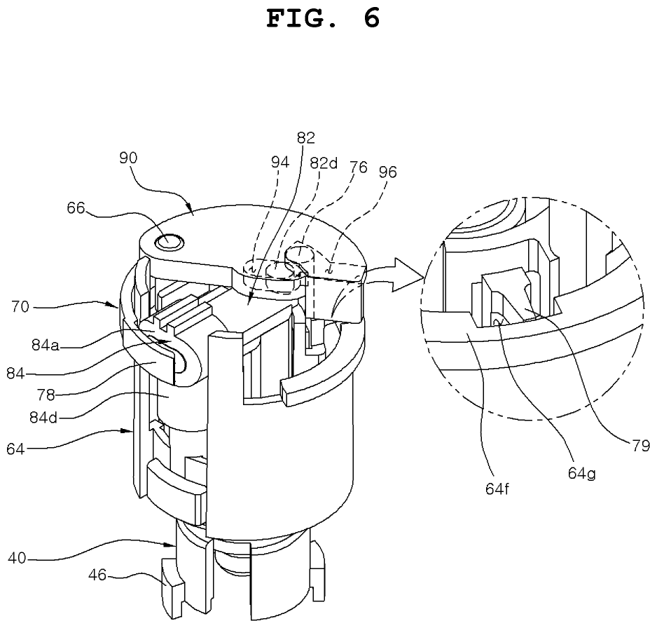

As shown in FIG. 6, the discharge member moving plate 90 may have a rotation shaft hole 92 axially coupled to the rotation shaft 66 of the rotation lifting/lowering member 60, an operation protrusion insertion groove 94 into which the operation protrusion 82d of the discharge member 80 is inserted, and a fixing rod insertion groove 96 into which the fixing rod 76 of the lifting/lowering member 70 is inserted. In this case, the operation protrusion insertion groove 94 may extend horizontally so that the operation protrusion 82d may fluctuate within the operation protrusion insertion groove 94, and the fixing rod insertion groove 96 is preferably folded (bent) at a middle thereof so that the discharge member moving plate 90 may axially rotate about the rotation shaft 66.

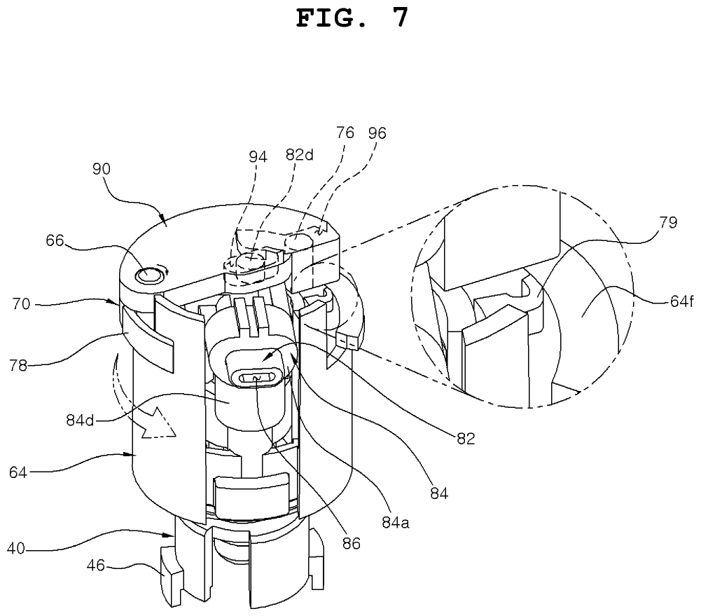

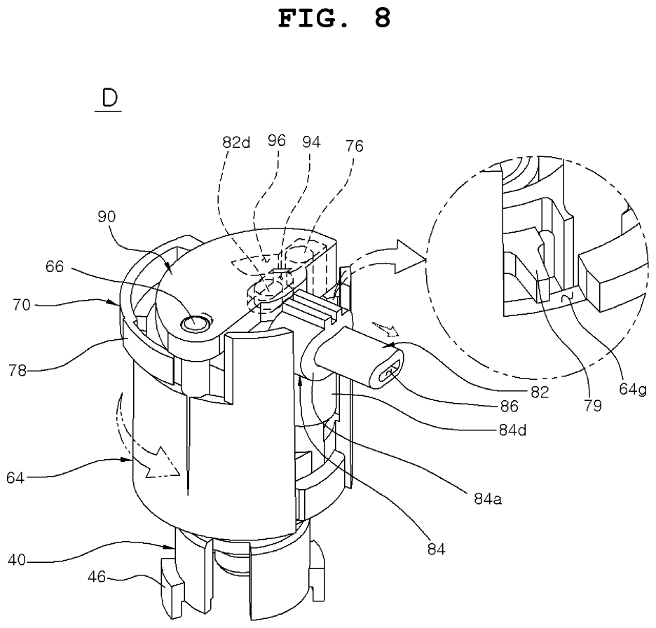

In more detail, when the second rotation lifting/lowering member 64 is rotated by the rotation operation cap 50, the discharge member moving plate 90 may move along the rotation shaft 66 of the second rotation lifting/lowering member 64. In this case, as shown in FIGS. 7 and 8, the fixing rod 76 of the lifting/lowering member 70 is fitted into the fixing rod insertion groove 96 of the discharge member moving plate 90, so that the discharge member moving plate 90 may be axially rotated toward a center of the rotation shaft 66 by the fixing rod 76. At the same time, since the operation protrusion 82d of the discharge member 80 is inserted into the operation protrusion insertion groove 96 of the discharge member moving plate 90, the discharge member 80 may be pushed by the discharge member moving plate 90 so as to linearly move forward or rearward, so that the discharge member 80 may be inserted into the push button 100 or may protrude out of the push button 100.

The push button 100 may be pressed by the user to operate the discharge device 30, may be at least partially coupled to the first rotation lifting/lowering member 62 while being inserted into the rotation operation cap 50, and may move up and down while rotating together with the first rotation lifting/lowering member 62.

As shown in FIGS. 2 and 3, the push button 100 may be formed on one side thereof with a discharge part outlet 102 through which the discharge part 82 of the discharge member 80 protrudes or is inserted, and a push button fastening groove 104 coupled to the push button fastening protrusion 62d of the first rotation lifting/lowering member 62 may be formed under the discharge part outlet 102.

As described above, according to the cosmetic container of one embodiment of the present invention, a vertical movement of the push button 100 by the rotation operation of the rotation operation cap 50, a protruding or inserting operation of the discharge part 82, and an opening or closing operation of the first to third content discharge passages 42, 64c, and 82a are automatically performed simultaneously or consecutively, so that the sealing ability inside the container and a convenience of use may be improved when storing or carrying the container.

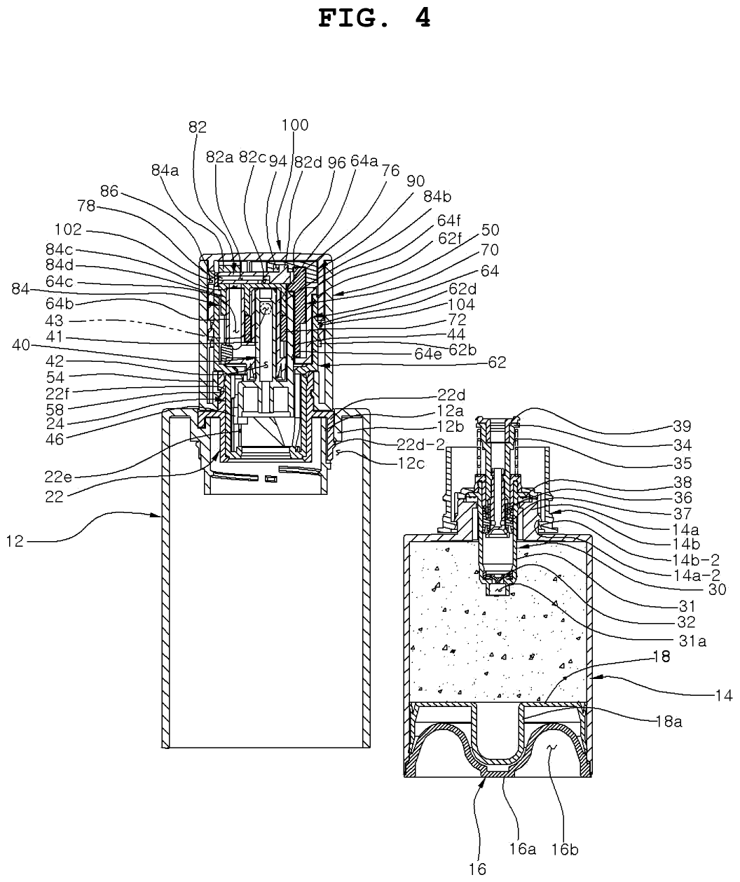

FIGS. 4 to 11 are views illustrating assembly and operation states of the cosmetic container according to one embodiment of the present invention, and a process of assembling and using the cosmetic container according to one embodiment of the present invention will be described with reference to FIGS. 4 to 11.

First, the first and second fixing guide members 22 and 24 may be installed in the installation hole 13 of the container body 12. While inserting the lower extension protrusion wheel 22d of the first fixing guide member 22 between the coupling inner wall 12a and the coupling outer wall 12b of the container body 12, the vertical fastening groove 22d-1 and the fastening protrusion 22d-2 may be coupled to the vertical fastening bar 12c and the fastening groove 12d of the container body 12, respectively, and the second fixing guide member 24 may be coupled to the inner side of the first fixing guide member 22 while being inserted into the top of the first fixing guide member 22.

Next, while inserting the fixing member 40 into the second fixing guide member 24, the vertical guide protrusion 46 of the fixing member 40 may be fitted into the vertical guide groove 22e of the first fixing guide member 22.

Then, the rotation operation cap 50 may be rotatably coupled to the outer side of the first fixing guide member 22, and the guide protrusion 62a of the first rotation lifting/lowering member 62 may be fitted into the spiral guide groove 26 of the fixing guide member 20 while inserting the first rotation lifting/lowering member 62 into the rotation operation cap 50. In this case, the seating protrusion part 62b of the first rotation lifting/lowering member 62 may be seated on the top of the seating part 54 of the rotation operation cap 50, and the insertion part 62c of the first rotation lifting/lowering member 62 may be inserted into the insertion space 56 of the rotation operation cap 50.

Thereafter, the second rotation lifting/lowering member 64 may be inserted into the first rotation lifting/lowering member 62, and the lifting/lowering member 70 may be coupled to an inner upper portion of the second rotation lifting/lowering member 64. In this case, while allowing the rotation limiting part 44 of the fixing member 40 to pass through the vertical through-hole 64e of the second rotation lifting/lowering member 64, the seating protrusion part 64f of the second rotation lifting/lowering member 64 may be seated on the seating sill 62f of the first rotation lifting/lowering member 62, and the insertion ring 72 of the lifting/lowering member 70 may be fitted to the outer side of the center insertion pipe 64a of the second rotation lifting/lowering member 64.

Next, the discharge member 80 including the discharge part 82 and the guide part 84 may be coupled to the center insertion pipe 64a and the second content discharge pipe 64b of the second rotation lifting/lowering member 64.

Then, while axially coupling the discharge member moving plate 90 to the second rotation lifting/lowering member 64, the discharge member moving plate 90 may be connected to the fixing rod 76 of the lifting/lowering member 70 and the operation protrusion 82d of the discharge member 80. In other words, the rotation shaft 66 of the second rotation lifting/lowering member 64 may be fitted into the rotation shaft hole 92 of the second rotation lifting/lowering member 64, the operation protrusion 82d of the discharge member 80 may be inserted into the operation protrusion insertion groove 94, and the fixing rod 76 of the lifting/lowering member 70 may be inserted into the fixing rod insertion groove 96.

Next, while covering an upper portion of the first rotation lifting/lowering member 62 with the push button 100, the push button fastening protrusion 62d of the first rotation lifting/lowering member 62 may be coupled to the push button fastening groove 104 of the push button 100.

Thereafter, the push plate 18 may be inserted into the open bottom of the refill container 14, the rotation guide member 16 may be fixedly coupled to the refill container 14, the contents may be filled in the refill container 14 through the inlet part 14a of the refill container 14, and the discharge device 30 including the cylinder 31, the suction valve plate 32, the sealing member 33, the vertical movement member 34, the elastic member 35, the operation discharge pipe 36, and the operation discharge ring 37 may be installed in the inlet part 14a of the refill container 14. In this case, before installing the discharge device 30 inside the refill container 14, the sealing ring 38 may be further coupled to the discharge device 30.

Next, the coupling member 14b may be coupled to the outer side of the inlet part 14a of the refill container 14, in which the second rotation prevention protrusion 14b-1 and the second separation prevention protrusion wheel 14b-2 of the coupling member 14b may be coupled to the first rotation prevention protrusion 14a-1 and the first separation prevention protrusion wheel 14a-2 of the inlet part 14a, respectively, so that the coupling member 14b may be prevented from idling respect to the refill container 14 or from being separated from the refill container 14.

Thereafter, as shown in FIG. 4, the container body 12 and the refill container 14, which are separately assembled, may be coupled to each other, such that the refill container 14 may be screw-coupled to the open bottom of the container body 12 by rotating the refill container 14 while completely inserting the refill container 14 into the open bottom of the container body 12.

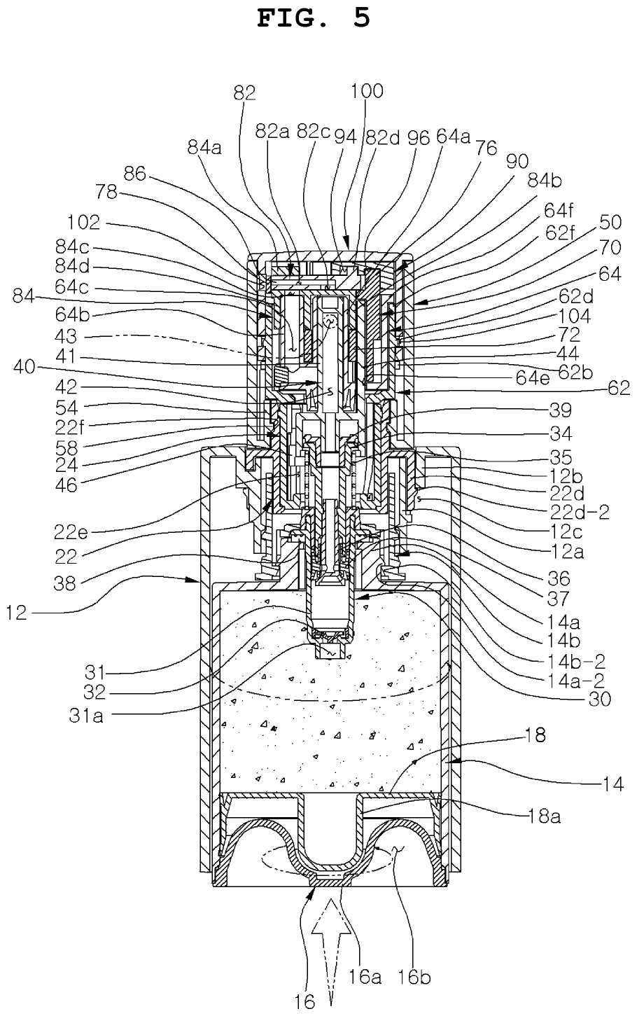

Meanwhile, when the contents accommodated in the refill container 14 is exhausted so that the refill container 14 needs to be replaced, the refill container 14 from which the contents are exhausted may be decoupled from the container body 12 by gripping the rotation handle 16a while the finger is inserted into the finger insertion groove 16b of the rotation guide member 16 and rotating the refill container 14 in one direction, and as shown in FIG. 5, a new refill container 14 may be coupled to the open bottom of the container body 12 by rotating the new refill container 14 while inserting the new refill container 14 into the open bottom of the container body 12. In this case, as shown in FIG. 3, the discharge device 30 installed in the refill container 14 may be automatically connected to the fixing guide member 20 installed in the container body 12.

In order to use the cosmetic container with the convenient refill structure, which is assembled as described above, first, the container body 12 may be gripped with one hand, and the rotation operation cap 50 may be gripped with the other hand to rotate the rotation operation cap 50 in a counterclockwise direction.

When the rotation operation cap 50 is rotated in the counterclockwise direction, as the first and second rotation lifting/lowering members 62 and 64 are rotated and lifted, the lifting/lowering member 70, the discharge member 80, the discharge member moving plate 90, and the push button 100 coupled to the upper portions of the first and second rotation lifting/lowering members 62 and 64 may be moved upward, the discharge part 82 of the discharge member 80 may be horizontally and linearly moved by the discharge member moving plate 90 so as to protrude out of the push button 100, and the first content discharge passage 42 of the fixing member 40, the second content discharge passage 64c of the second rotation lifting/lowering member 64, and the third content discharge passage 82a of the discharge member 80 may be connected to each other.

In more detail, as the first rotation lifting/lowering member 62 is rotated by the rotation operation of the rotation operation cap 50 so that the guide protrusion 62a of the first rotation lifting/lowering member 62 moves upward along the spiral guide groove 26 of the fixing guide member 20, the second rotation lifting/lowering member 64 coupled to an upper inner side of the first rotation lifting/lowering member 62, the discharge member 80 and the discharge member moving plate 90 coupled to an upper portion of the second rotation lifting/lowering member 64, and the push button 100 coupled to an upper portion of the first rotation lifting/lowering member 62 may rotate together so as to be moved upward. Meanwhile, the lifting/lowering member 70 inserted into the upper inner side of the second rotation lifting/lowering member 64 is coupled to the fixing member 40 so as to move vertically and linearly without rotating.

When the second rotation lifting/lowering member 64 is rotated as described above, the discharge member moving plate 90 axially coupled to the rotation shaft 66 of the second rotation lifting/lowering member 64 may move along the second rotation lifting/lowering member 64. In this case, as shown in FIG. 6, the operation protrusion 82d of the discharge member 80 and the fixing rod 76 of the lifting/lowering member 70 are inserted into the operation protrusion insertion groove 94 and the fixing rod insertion groove 96 of the second rotation lifting/lowering member 64, respectively. Accordingly, as shown in FIGS. 7 to 8, the discharge member moving plate 90 may be axially rotated toward the center about the rotation shaft 66 of the second rotation lifting/lowering member 64 by the fixing rod 76, while the discharge part 82 of the discharge member 80 is pushed by the discharge member moving plate 90 so as to linearly move forward, so that the discharge part 82 may protrude through the discharge part outlet 102 of the push button 100.

In addition, while the discharge member 80 is rotated according to the second rotation lifting/lowering member 64, the lifting/lowering member 70 is fitted to the fixing member 40 so as not to be rotated, so that the discharge port 82, which is hidden behind the blocking part 78 of the lifting member 70, may laterally deviate from the blocking part 78 so as to be exposed to the outside.

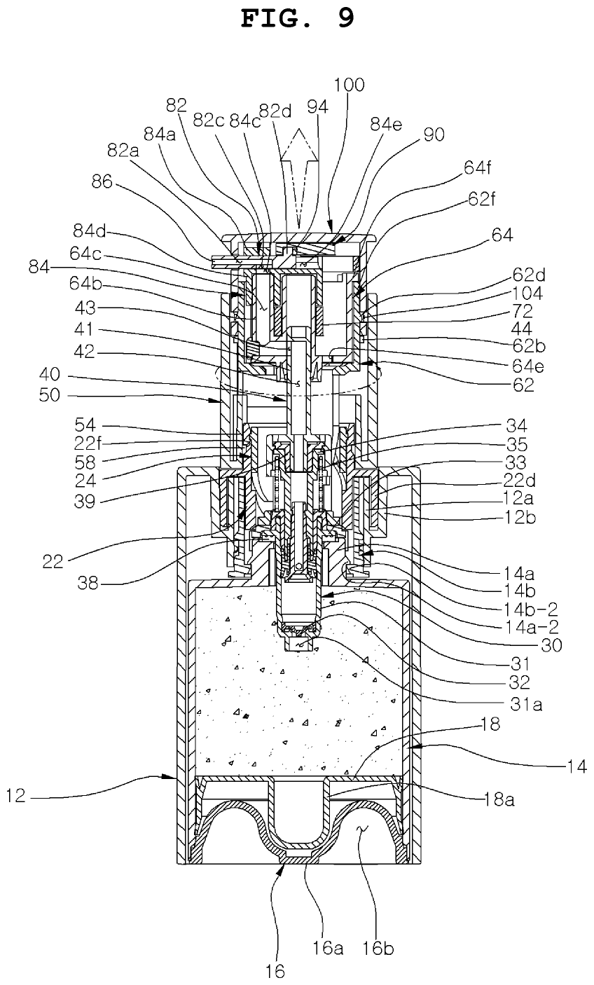

Thereafter, when the rotation operation cap 50 is continuously rotated in the counterclockwise direction, one end of the vertical through-hole 64e of the second rotation lifting/lowering member 64 may be latched to the rotation limiting part 44 of the fixing member 40, so that the rotation of the second rotation lifting/lowering member 64 may stop. At that moment, as shown in FIG. 9, the first content discharge passage 42 of the fixing member 40, the second content discharge passage 64c of the second rotation lifting/lowering member 64, and the third content discharge passage 82a of the discharge member 80 may be connected to each other. In other words, as the discharge part 82 of the discharge member 80 linearly moves forward, the third discharge hole 82c formed in the discharge part 82 and the connection hole 84c formed in the guide part 84, which are misaligned, may match each other, so that the second content discharge passage 64c and the third content discharge passage 82a may be connected to each other.

At the same time, the push button 100 may be exposed to the top of the rotation operation cap 50, and the guide protrusion 62a of the first rotation lifting/lowering member 62 may be located in the vertical guide groove 22e of the first fixing guide member 22, so that the push button 100 may be able to be pressed.

In this case, the friction protrusion 79 of the lifting/lowering member 70 may be inserted into one friction protrusion insertion groove 64g formed in the second rotation lifting/lowering member 64 in a fixed state, may be pressed against an inner wall of the second rotation lifting/lowering member 64, which is rotated when the rotation operation cap 50 is rotated, so as to be bent, and may be elastically inserted into another friction protrusion insertion groove 64g when the second rotation lifting/lowering member 64 rotates by a predetermined distance.

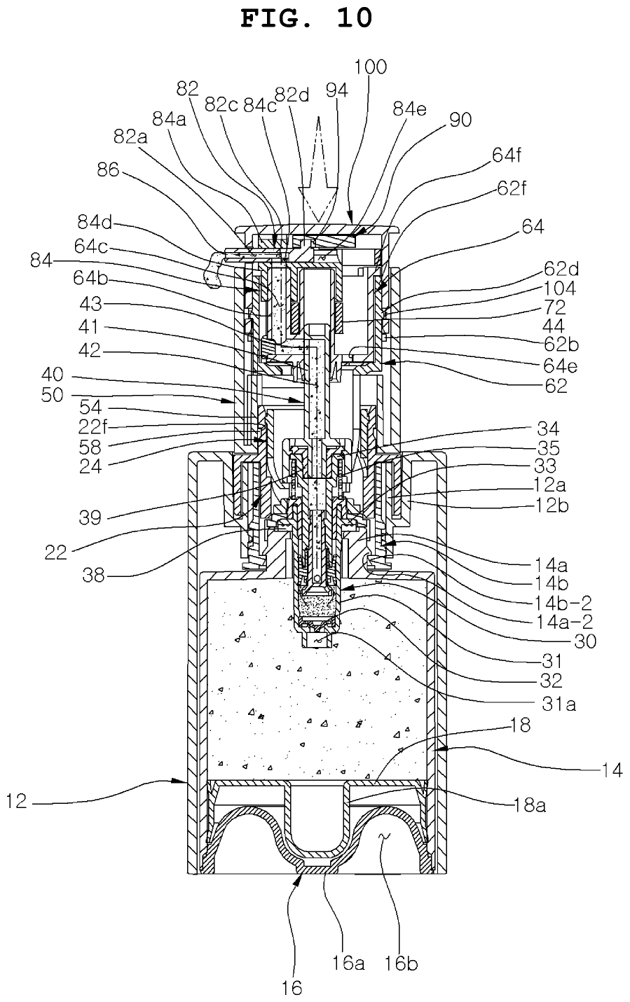

Next, when the push button 100 is vertically pressed as shown in FIG. 10 in order to discharge the contents from the cosmetic container, as the first rotation lifting/lowering member 62 coupled with the push button 100 moves downward, the guide protrusion 62a of the first rotation lifting/lowering member 62 may press the top of the vertical guide protrusion 46 of the fixing member 40, and the fixing member 40 may move the vertical movement member 34 of the discharge device 30 and the operation discharge pipe 36 coupled to a lower side of the vertical movement member 34 downward.

In this case, since the operation discharge ring 37 of the discharge device 30 makes close contact with the inner periphery of the cylinder 31, only the operation discharge pipe 36 may be moved downward so as to generate a gap between the operation discharge pipe 36 and the operation discharge ring 37, so that a discharge passage for the contents may be generated.

Then, when the push button 100 is continuously pressed, a lower end of the vertical movement member 34 of the discharge device 30 may press the operation discharge ring 37, so that a volume inside the cylinder 31 may be reduced as the operation discharge ring 37 moves downward together with the operation discharge pipe 36. Accordingly, the suction valve plate 32 may close the content suction port 31a by a discharge pressure in the cylinder 31, and simultaneously, the contents temporarily stored in the cylinder 31 may be discharged between the operation discharge pipe 36 and the operation discharge ring 37 to pass through the first content discharge passage 42 of the fixing member 40, the second content discharge passage 64c of the second rotation lifting/lowering member 64, and the third content discharge passage 82a of the discharge member 80 so as to be discharged to the outside through the discharge port 86 of the discharge part 82.

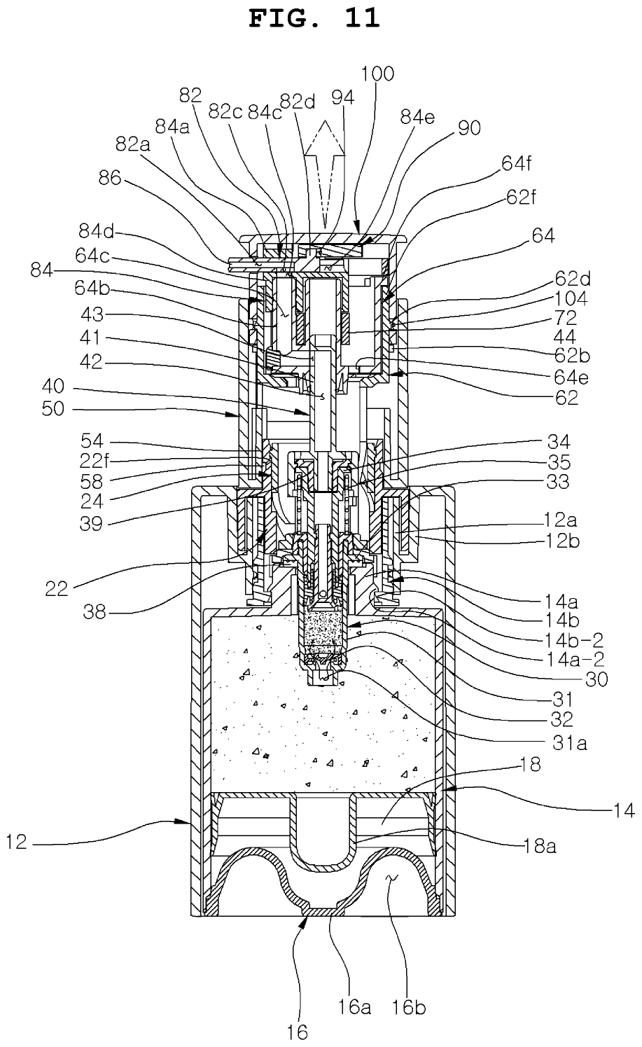

Thereafter, as shown in FIG. 11, when the pressure of the push button 100 is released, the vertical movement member 34, the fixing member 40, the first rotation lifting/lowering member 62, and the push button 100 may move upward together with each other by elasticity of the elastic member 35, and the operation discharge pipe 36 coupled to the lower side of the vertical movement member 34 may also move upward. In this case, as the operation discharge pipe 36 pulls the operation discharge ring 37 upward, the gap between the operation discharge pipe 36 and the operation discharge ring 37 may be blocked, so that the operation discharge pipe 36 and the operation discharge ring 37 may move upward together with each other. Accordingly, the volume inside the cylinder 31 may be increased, so that a vacuum pressure may be generated.

Next, the suction valve plate 32 may be lifted by the vacuum pressure generated inside the cylinder 31 so as to open the content suction port 31a, so that the contents accommodated inside the refill container 14 may be introduced into the cylinder 31 through the content suction port 31a while the push plate 18 inserted in the refill container 14 moves toward the discharge device 30.

Meanwhile, when the rotation operation cap 50 is rotated in a clockwise direction after the cosmetic container is used, as shown in FIG. 3, the whole of the second rotation lifting/lowering member 64, the lifting/lowering member 70, the discharge member 80, the discharge member moving plate 90, and the push button 100 may be lowered by the first rotation lifting/lowering member 62, so that the first content discharge passage 42 of the fixing member 40 and the second content discharge passage 64c of the second rotation lifting/lowering member 64 may be blocked. At the same time, as the discharge member moving plate 90 is axially rotated toward an outer wall of the push button 100, the discharge port 82 of the discharge member 80 may be linearly pulled by the discharge member moving plate 90 so as to be inserted into the push button 100, and the second content discharge passage 64c of the second rotation lifting/lowering member 64 and the third content discharge passage 82a of the discharge member 80 may be blocked.

In this case, the guide protrusion 62a of the first rotation lifting/lowering member 62 may be located in the spiral guide groove 26 of the fixing guide member 20, so that the push button 100 may not be pressed. In addition, while the discharge member 80 rotates according to the second rotation lifting/lowering member 64 so as to be lowered, the lifting member 70 is fitted to the fixing member 40 so as to be lowered without being rotated, so that the discharge port 82 of the discharge member 80 may be hidden behind the blocking part 78 of the lifting/lowering member 70.

Although the above description has been made with reference to illustrative embodiments and drawings as well as certain matters such as specific elements, the embodiments are provided for overall understanding of the present invention, and the present invention is not limited to the embodiments. It is understood by those skilled in the art that various changes and modifications can be made in these embodiments.

Therefore, the spirit of the present invention should not be construed as being limited to the embodiments described herein, and all variations within the scope of the appended claims and their equivalents are to be construed as being included in the scope of the present invention.

What is claimed is:

1. A cosmetic container with a convenient refill structure, the cosmetic container comprising:
a container body;
a refill container coupled to the container body, and accommodated therein with contents;
a rotation guide member coupled to the refill container, and at least partially exposed to an outside; and
a discharge unit for discharging the contents accommodated in the refill container to the outside,
wherein the refill container is screw-coupled to the container body while being inserted into an open bottom of the container body, and
the rotation guide member has a finger insertion groove recessed inward of the refill container.

2. The cosmetic container of claim 1, wherein the container body is provided on an inner side thereof with a coupling protrusion wheel having a screw thread, and the refill container is provided at an inlet part thereof with a coupling member having a screw thread, such that the coupling protrusion wheel and the coupling member are screw-coupled to each other.

3. The cosmetic container of claim 1, wherein the discharge unit includes:
a fixing guide member fixedly coupled to the container body, and having a spiral guide groove;
a discharge device for discharging the contents accommodated in the refill container;
a fixing member connected to the discharge device, and having a first content discharge passage;
a rotation operation cap rotatably coupled to an outer side of the fixing guide member;
a rotation lifting/lowering member lifted/lowered while being rotated by the rotation operation cap, and having a guide protrusion and a second content discharge passage;
a lifting/lowering member vertically moved up and down by the rotation lifting/lowering member;
a discharge member coupled to the rotation lifting/lowering member, and having a discharge port and a third content discharge passage;
a discharge member moving plate axially coupled to the rotation lifting/lowering member to horizontally move the discharge member; and
a push button lifted/lowered while being rotated together with the rotation lifting/lowering member, and formed on one side thereof with a discharge part outlet.

4. The cosmetic container of claim 3, wherein the discharge device includes a pump for discharging the contents by a pumping operation.

5. The cosmetic container of claim 1, wherein when the refill container and the container body are coupled to each other, the refill container is completely inserted into the open bottom of the container body, the discharge device of the discharge unit is installed in the refill container, and remaining components of the discharge unit except for the discharge device are installed in the container body, such that the discharge device and the remaining components of the discharge unit are connected to each other.

6. The cosmetic container of claim 1, wherein the rotation guide member is provided at a lower portion thereof with a rotation handle passing through a center of the rotation guide member, and
finger insertion grooves are formed on both sides of the rotation handle, respectively, so that a finger is inserted into the finger insertion groove when the container body and the refill container are coupled to and decoupled from each other.
